(19) United States
(12) Patent Application Publication
(10) Pub. No.: US 2006/0056524 A1
(43) Pub. Date: Mar. 16, 2006

(54) Apparatus and method for providing digital broadcasting service based on multiple broadcasting sites and frequency bands

(76) Inventors: Sammo Cho, Daejon (FR); Hyun Lee, Daejon (KR); Soo-In Lee, Daejon (KR); Chieteuk Ahn, Daejon (KR)

Correspondence Address: LADAS & PARRY LLP, 224 SOUTH MICHIGAN AVENUE, SUITE 1600, CHICAGO, IL, 60604, US

(21) Appl. No.: 10/540,892

(22) PCT Filed: Oct. 21, 2003
(86) PCT No.: PCT/KR03/02215

§ 371 Date: Jun. 27, 2005

(30) Foreign Application Priority Data
Dec. 26, 2002 (KR) 10-2002-0084462

(51) Int. Cl. H04K 1/10

(52) U.S. Cl. 375/260

(57) ABSTRACT

An apparatus for transmitting data in a digital broadcasting system is disclosed. The apparatus includes: a source encoding unit for encoding data to be transmitted and generating source-coded data; a capacity managing unit for dividing the source-coded data into divided data for a plurality of channels in case that an available data capacity for transmitting the source-coded data does not exist in one channel but sum of available data capacities of the multiple channels can accommodate the source-coded data, and adding header information to the divided data; a channel encoding unit for encoding the divided data according to channel environment and generating channel-coded data; and a transmitting unit for multiplexing, modulating and transmitting the channel-coded data through multiple frequency bands and multiple broadcasting sites.

### TECHNICAL FIELD

The present invention relates to an apparatus and method for providing a digital broadcasting service based on multiple frequency bands; and, more particularly, to an apparatus and method for transmitting data through a plurality of frequency bands transmitted from the plurality of broadcasting sites, in which the data is divided, header information is added into the divided data so as to reconstruct the data in a receiving apparatus when an available channel for transmitting the data does not exist but sum of the remnants of all or several channels can accommodate the necessary capacity, and an apparatus and method for receiving the data through multiple frequency bands.

### BACKGROUND ART

Generally, in conventional digital television broadcasting, digital satellite broadcasting and digital audio broadcasting, certain frequency bands are allocated to digital broadcasting systems according to domestic or international service standards. These standards allow broadcasting services, e.g., audio, video or data broadcasting, using one of the frequency bands. In this case, a data transfer capacity of the digital broadcasting service is limited to the maximum data transfer capacity of the allocated frequency band.

As new data application services require larger data capacity in the future, technical and financial problems arise so as to meet the required demand of the increased data transfer capacity.

### DISCLOSURE OF THE INVENTION

It is, therefore, an object of the present invention to provide a transmitting apparatus and method for dividing data in order to transmit data through a plurality of channels and transmitting data having header information so as to reconstruct the data in a receiving apparatus.

It is another object of the present invention to provide the receiving apparatus and method for receiving and combining the data.

In accordance with an aspect of the present invention, there is provided an apparatus for transmitting data in a digital broadcasting system, including: a source encoding unit for encoding data to be transmitted and generating source-coded data; a capacity managing unit for dividing the source-coded data into divided data for a plurality of channels in case that an available data capacity for transmitting the source-coded data does not exist in one channel but sum of available data capacities of multiple channels can accommodate the source-coded data and adding header information to the divided data; a channel encoding unit for encoding the divided data according to channel environment and generating channel-coded data; and a transmitting unit for multiplexing, modulating and transmitting the channel-coded data through multiple frequency bands and multiple broadcasting sites.

In accordance with another aspect of the present invention, there is provided an apparatus for receiving data in a digital broadcasting system, including: a tuning unit for receiving transmitted data through multiple frequency bands and multiple broadcasting sites; a demodulating unit for demodulating the received data and generating demodulated data; a de-multiplexing unit for de-multiplexing the demodulated data and generating de-multiplexed data; a decoding unit for decoding the de-multiplexed data and generating decoded data; and a data combining unit for combining the decoded data.

In accordance with further another aspect of the present invention, there is provided a method for transmitting data in a digital broadcasting system, including the steps of: (a) encoding image data and audio data to be transmitted and generating source-coded data; (b) at a capacity managing means, dividing the source-coded data into divided data for a plurality of channels in case that an available data capacity for transmitting the source-coded data does not exist in one channel but sum of available data capacities of multiple channels can accommodate the source-coded data and adding header information to the divided data; (c) channel encoding the divided data according to channel environment and generating channel-coded data; and (d) multiplexing, modulating and transmitting the channel-coded data through multiple frequency bands and multiple broadcasting sites.

In accordance with still further another aspect of the present invention, there is provided a method for receiving data in a digital broadcasting system, including the steps of: (a) receiving transmitted data through multiple frequency bands and multiple broadcasting sites; (b) demodulating the received data for each frequency band and generating demodulated data; (c) de-multiplexing the demodulated data for each frequency bands and generating de-multiplexed data; (d) decoding the de-multiplexed data for each frequency bands and generating decoded data; and (e) at combining means, combining the decoded data.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a transmitting apparatus for a digital broadcasting service using multiple frequency bands in accordance with a preferred embodiment of the present invention;

FIG. 2 is a flowchart showing a transmitting method for a digital broadcasting service using multiple frequency bands in accordance with the present invention;

FIG. 3 is a block diagram showing packets used in a digital broadcasting service in accordance with the present invention;

FIG. 4 is a block diagram showing a receiving apparatus for a digital broadcasting service in accordance with an embodiment of the present invention;

FIG. 5 is a block diagram showing a receiving apparatus for a digital broadcasting service in accordance with another embodiment of the present invention; and

FIG. 6 is a block diagram showing a digital broadcasting system using multiple frequency bands in accordance with the present invention.

### BEST MODE FOR CARRYING OUT THE INVENTION

Other objects and aspects of the invention will become apparent from the following description of the embodiments with reference to the accompanying drawings, which is set forth hereinafter.

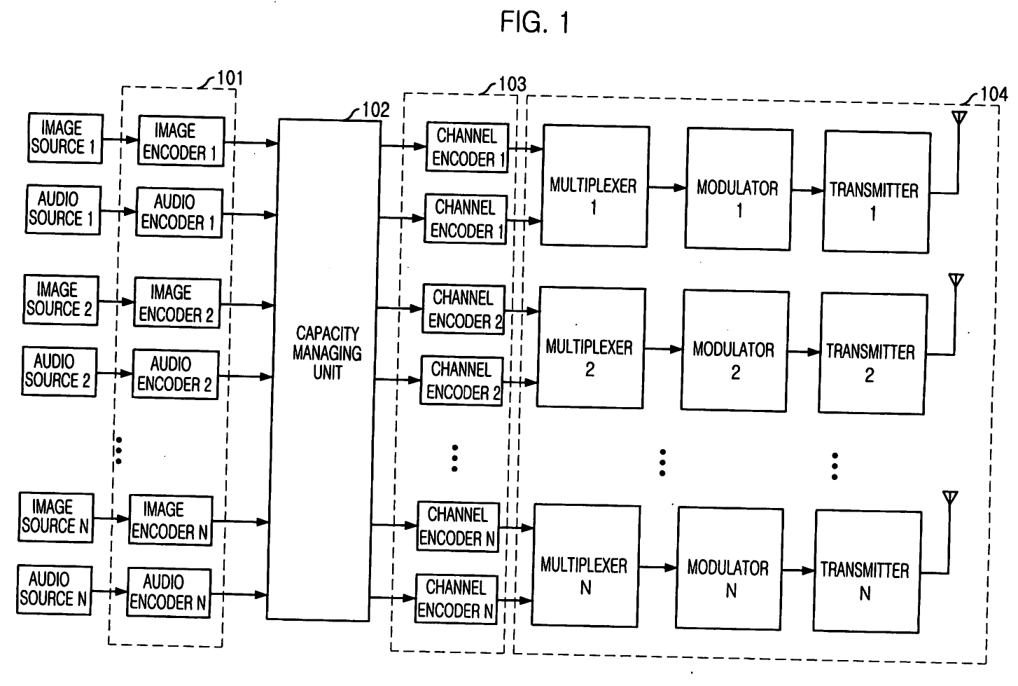

FIG. 1 is a block diagram showing a transmitting apparatus for a digital broadcasting service using multiple frequency bands in accordance with a preferred embodiment of the present invention.

Referring to FIG. 1, the transmitting apparatus for a digital broadcasting service using multiple frequency bands includes a source encoding unit 101, a capacity managing unit 102, a channel encoding unit 103 and a transmitting unit 104.

The source encoding unit 101 has a plurality of encoders each of which has pairs of an image encoder and an audio encoder and encodes the data to be transmitted to generate source-coded data. The capacity managing unit 102 receives the source-coded data from the source encoding unit 101, divides the source-coded data into a plurality of divided data for several channels and adds header information so as to reconstruct the data when an available channel for the data is not found.

The channel encoding unit 103 has channel encoders and the transmitting unit 104 has multiplexers, modulators and transmitters. The channel encoding unit 103 encodes the divided data according to a channel environment to generate channel-coded data. The transmitting unit 104 multiplexes, modulates and transmits the channel-coded data.

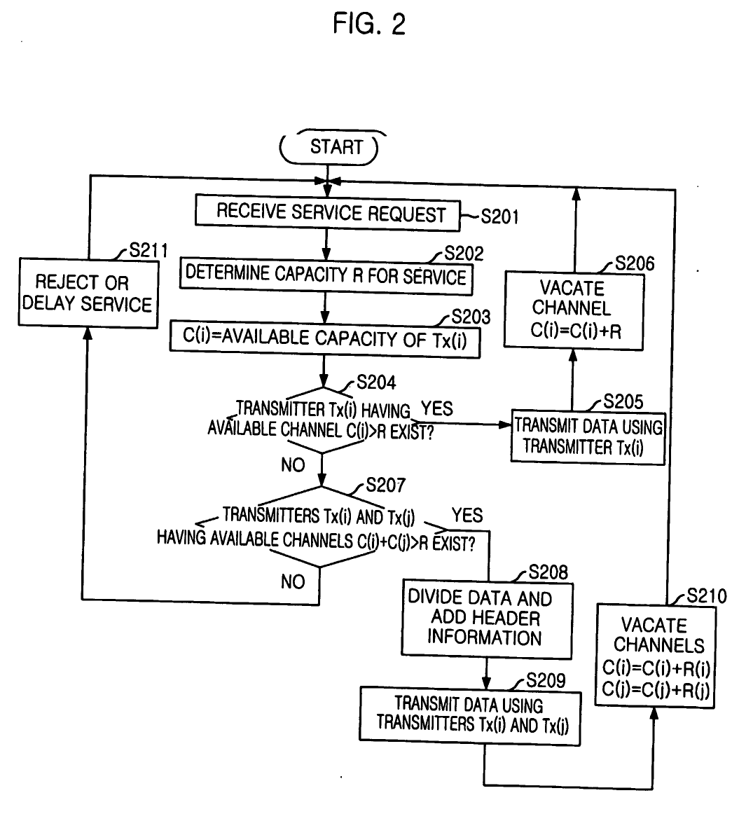

FIG. 2 is a flowchart showing a transmitting method for a digital broadcasting service using multiple frequency bands in accordance with the embodiment of the present invention.

Although the embodiment of the present invention is explained with two transmitters, the number of transmitters is not limited in the present invention.

Referring to FIG. 2, at step S201, a request for transferring data is received. At step S202, required data throughput to transfer the data is determined. At step S203, data throughputs of available transmitters are determined. At step S204, an available transmitter for transferring the data is searched. At step S205, if the available transmitter Tx(i) exists, the data are transferred through the transmitter Tx(i). At step S206, emptiness of the channel is notified to the capacity managing unit 102 and process continues to step S201.

If an available transmitter Tx(i) does not exist, at step S207, it is determined whether the data can be transferred using transmitters Tx(i) and Tx(j). If the data can not be transferred through the transmitters Tx(i) and Tx(j), at step 211, the request for transferring the data is rejected or delayed and the process continues to the step S201.

If the data can be transferred through the transmitters Tx(i) and Tx(j), at step S208, the data are divided into R(i) and R(j), and header information is added to each divided data.

At step S209, the divided data are transferred. At step S210, it is notified to the capacity managing unit 102 that the channel is vacated and the process continues to step S201.

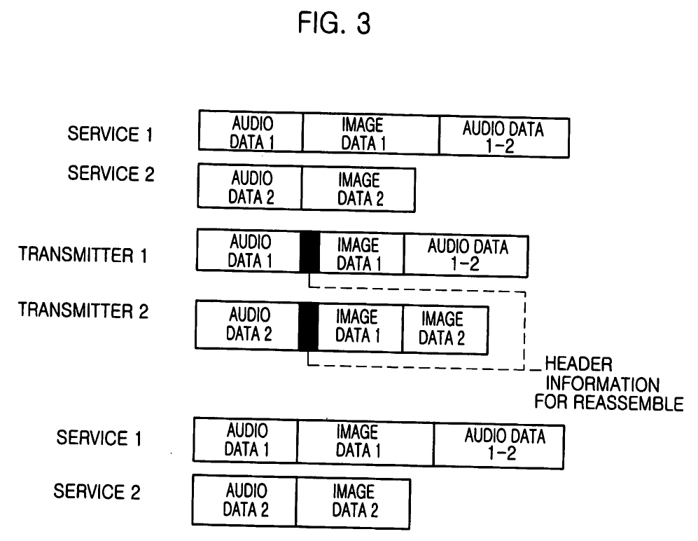

FIG. 3 is a block diagram showing packets used in a digital broadcasting service in accordance with the embodiment of the present invention. When data cannot be transmitted through one transmitter, the capacity managing unit 102 divides the data and the divided data are transmitted through a first transmitter and a second transmitter. The receiving apparatus receives the divided data packets and reconstructs data packets.

Referring to FIG. 3, when data of first service can not transferred through a first transmitter, first image data are divided, and header information is added to each divided data so as to reconstruct the data in a receiving apparatus. The divided data are transferred through the first transmitter and the second transmitter. The receiving apparatus receives the data and reconstructs based on the header information.

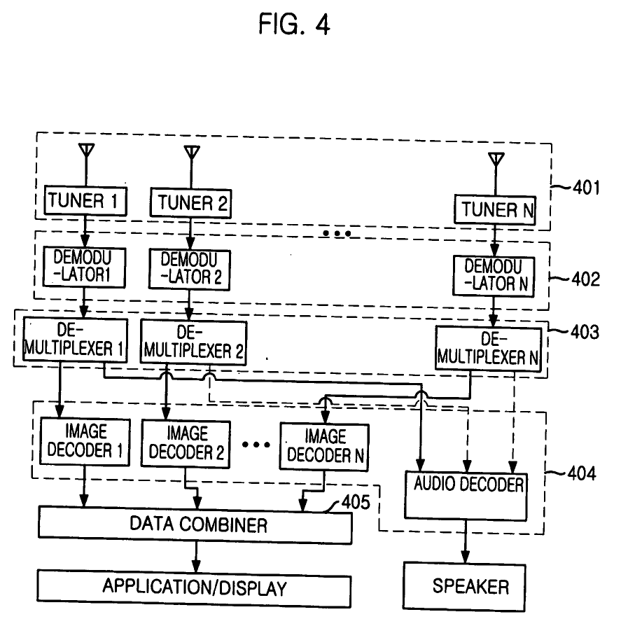

FIG. 4 is a block diagram showing a receiving apparatus for a digital broadcasting service in accordance with an embodiment of the present invention.

Referring to FIG. 4, the receiving apparatus for digital broadcasting service includes a receiving unit 401, a demodulating unit 402, a de-multiplexing unit 403, a decoding unit 404 and a data combining unit 405.

The receiving unit 401 has tuners for receiving transmitted data, the demodulating unit 402 demodulates the received data, the de-multiplexing unit 403 de-multiplexes the demodulated data to have image data and audio data, a decoding unit 404 having image decoders and voice decoders decodes the image data and the audio data, and a data combiner combines the image data.

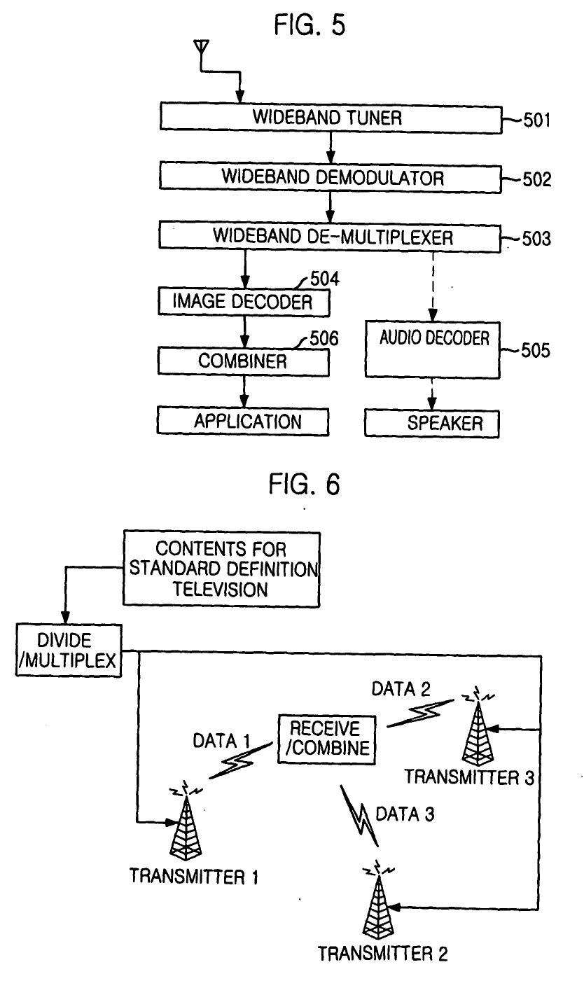

FIG. 5 is a block diagram showing a receiving apparatus for a digital broadcasting service in accordance with another embodiment of the present invention.

Referring to FIG. 5, the receiving apparatus for digital broadcasting service includes a wideband tuner 501, a wideband demodulator 502, a wideband de-multiplexer 503, an image decoder 504, an audio decoder 505 and a data combiner 506.

The broadband tuner 501 receives the data. The broadband demodulator 502 receives the data from the broadband tuner 501 and demodulates the data. The broadband de-multiplexer 503 receives the data from the broadband demodulator 502 and demodulates the data. The image decoder decodes the image data, the audio decoder 505 decodes the audio data and the data combiner 506 combines the image data.

FIG. 6 is a block diagram showing a digital broadcasting system using multiple frequency bands in accordance with the present invention.

Contents for a standard definition television (SDTV) are collected by cameras. The data are divided and transferred through the transmitters to the receiving apparatus. The receiving apparatus receives the data and reconstructs the data. Therefore, limited frequency bandwidth of digital broadcasting service can be used efficiently by using the apparatus and method of the present invention.

As mentioned above, the present invention can provide an efficient digital broadcasting service by transmitting data through a plurality of frequency bands while the aximum data transfer rate is limited in the conventional digital broadcasting system because a broadcasting station as a certain frequency band to transmit different services.

Also, the present invention can provide a system having higher data transfer rate than a conventional digital broadcasting service having only one frequency band. Therefore, the present invention can meet various needs of service users.

While the present invention has been described with respect to certain preferred embodiments, it will be apparent to those skilled in the art that various changes and modifications may be made without departing from the scope of the invention as defined in the following claims.

What is claimed is:

1. An apparatus for transmitting data in a digital broadcasting system, comprising:
a source encoding means for encoding data to be transmitted and generating source-coded data;
a capacity managing means for dividing the source-coded data into divided data for a plurality of channels in case that an available data capacity for transmitting the source-coded data does not exist in one channel but sum of available data capacities of several channels can accommodate the source-coded data, and adding header information to the divided data;
a channel encoding means for encoding the divided data according to channel environment and generating channel-coded data; and
a transmitting means for multiplexing, modulating and transmitting the channel-coded data through multiple frequency bands and multiple broadcasting sites.

2. The apparatus as recited in claim 1, wherein the capacity managing means stores information of available capacity and unavailable capacity for each frequency band, divides the source-coded data in case that an available data capacity for transmitting the source-coded data does not exist in one channel but sum of the available data capacities of multiple channels can accommodate the source-coded data, and adds the header information to the divided data in a data packet so as to reconstruct the data in the receiving apparatus.

3. An apparatus for receiving data in a digital broadcasting system, comprising:
a tuning means for receiving transmitted data through multiple frequency bands and multiple broadcasting sites;
a demodulating means for demodulating the received data and generating demodulated data;
a de-multiplexing means for de-multiplexing the demodulated data and generating de-multiplexed data;
a decoding means for decoding the de-multiplexed data and generating decoded data; and
a data combining means for combining the decoded data.

4. The apparatus as recited in claim 3, wherein the combining means combines the data based on header information that is included in the decoded data.

5. A method for transmitting data in a digital broadcasting system, comprising the steps of:
(a) encoding image data and audio data to be transmitted and generating source-coded data ;
(b) at a capacity managing means, dividing the source-coded data into divided data for a plurality of channels in case that an available data capacity for transmitting the source-coded data does not exist in one channel but sum of available data capacities of multiple channels can accommodate the source-coded data, and adding header information to the divided data;
(c) channel encoding the divided data according to channel environment and generating channel-coded data; and
(d) multiplexing, modulating and transmitting the channel-coded data through multiple frequency bands and multiple broadcasting sites.

6. The method as recited in claim 5, wherein the capacity managing means stores information of available capacity and unavailable capacity for each frequency bands, divides the source-coded data in case that an available data capacity for transmitting the source-coded data does not exist in one channel but sum of available data capacities of the multiple channels can accommodate the source-coded data, and adds the header information in a data packet so as to reconstruct the data in the receiving apparatus.

7. A method for receiving data in a digital broadcasting system, comprising the steps of:
(a) receiving transmitted data through multiple frequency bands and multiple broadcasting sites;
(b) demodulating the received data for each frequency band and generating demodulated data;
(c) de-multiplexing the demodulated data for each frequency bands and generating de-multiplexed data;
(d) decoding the de-multiplexed data for each frequency bands and generating decoded data; and
(e) at combining means, combining the decoded data.

8. The method as recited in claim 7, wherein the combining means combines the data based on header information that is included in the decoded data.
